(19) United States
(12) Patent Application Publication
(10) Pub. No.: US 2022/0383427 A1
(43) Pub. Date: Dec. 1, 2022

(54) METHOD AND APPARATUS FOR GROUP DISPLAY

(71) Applicant: BEIJING DAJIA INTERNET INFORMATION TECHNOLOGY CO., LTD., Beijing (CN)

(72) Inventor: Shaoze GUO, Beijing (CN)

(21) Appl. No.: 17/886,074

(22) Filed: Aug. 11, 2022

Related U.S. Application Data
(63) Continuation of application No. PCT/CN2021/076490, filed on Feb. 10, 2021.

(30) Foreign Application Priority Data
Feb. 13, 2020 (CN) 202010091577.3

(51) Int. Cl. G06Q 50/00

(52) U.S. Cl. CPC G06Q 50/01

(57) ABSTRACT

A method and an apparatus for group display. The method includes: acquiring one or more target group types to be displayed in response to a group display operation of a user, in which the target group types are determined based on behavior data of the user; and acquiring groups corresponding to at least one of the target group types, and display the groups on a group display page.

### CROSS-REFERENCE TO RELATED APPLICATION

The present application is a continuation application of International Application No. PCT/CN2021/076490, filed on Feb. 10, 2021, which claims a priority to Chinese Patent Application No. 202010091577.3, filed on Feb. 13, 2020, the entirety contents of which are incorporated herein by reference.

### FIELD

The present disclosure relates to the field of front-end interaction technology, and in particular to a method and an apparatus for displaying groups.

### BACKGROUND

With development of Internet technology, users join groups to communicate with multiple users through social applications that provide social services (such as WeChat and QQ), which has become a very common way of social networking.

The users joining groups satisfying their social requirements for communication is a key to improving social experience of the users.

### SUMMARY

The present disclosure provides a method and an apparatus for displaying groups.

According to embodiments of the present disclosure, a method for displaying groups is provided. The method includes:

acquiring one or more target group types to be displayed in response to a group display operation of a user, in which the target group types are determined based on behavior data of the user; and

acquiring groups corresponding to at least one of the target group types, and displaying the groups on a group display page.

According to embodiments of the present disclosure, a method for displaying groups is provided. The method includes:

receiving behavior data of a user sent by a terminal, in which the behavior data of the user at least includes source page information of a group display operation or historical association behavior information of the user implemented on multimedia resources;

determining one or more target group types according to the behavior data of the user; and

sending the one or more target group types to the terminal to enable the terminal to acquire groups corresponding to at least one of the target group types and display the groups on a group display page in response to detecting the group display operation of the user.

According to embodiments of the present disclosure, an apparatus for displaying groups is provided. The apparatus includes:

a processor; and

a memory for storing executable instructions of the processor;

in which, the processor is configured to perform acts for implementing:

acquiring one or more target group types to be displayed in response to a group display operation of a user, in which the target group types are determined based on behavior data of the user; and

acquiring groups corresponding to at least one of the target group types, and display the groups on a group display page.

It should be understood that the above general description and the following detailed description are only exemplary and explanatory, and cannot limit the present disclosure.

### BRIEF DESCRIPTION OF THE DRAWINGS

The drawings here are incorporated into the specification and constitute a part of the specification, show embodiments conforming to the disclosure, and together with the specification are used to explain the principle of the disclosure.

FIG. 1 is a flowchart of a method for displaying groups according to an embodiment of the present disclosure.

FIG. 1A is a schematic diagram of a result of group display according to an embodiment of the present disclosure.

FIG. 2 is a flowchart of a method for determining one or more target group types according to an embodiment of the present disclosure.

FIG. 3A is a schematic diagram of acquiring a confidence coefficient for a group tag according to an embodiment of the present disclosure.

FIG. 3B is a schematic diagram illustrating another result of group display according to an embodiment of the present disclosure.

FIG. 4A is a schematic diagram of labeling a group tag according to an embodiment of the present disclosure.

FIG. 4B is a schematic diagram of acquiring a group tag according to an embodiment of the present disclosure.

FIG. 4C is a schematic diagram illustrating another result of group display according to an embodiment of the present disclosure.

FIG. 5 is a flowchart of another method for displaying groups according to an embodiment of the present disclosure.

FIG. 6 is a block diagram of an apparatus for displaying groups according to an embodiment of the present disclosure.

FIG. 7 is a block diagram of another apparatus for displaying groups according to an embodiment of the present disclosure.

### DETAILED DESCRIPTION

In order to enable those skilled in the art to understand the technical solutions of the present disclosure, reference will be made clearly and completely technical solutions in the embodiments of the present disclosure with accompanying drawings.

It should be noted that terms “first” and “second” in the specification and claims of the present disclosure and the accompanying drawings are used to distinguish similar objects, rather than to describe a specific order or sequence. It should be understood that data used in such a manner may be interchanged under appropriate circumstances so that embodiments of the present disclosure described herein may be implemented in a sequence other than the sequence illustrated or described herein. The implementations described in the following exemplary embodiments do not represent all implementations consistent with the present disclosure; instead, the implementations described in the following exemplary embodiments are merely examples of an apparatus and method consistent with the attached claims and some aspects of the present disclosure. All embodiments of the present disclosure can be implemented alone or in combination with other embodiments, which will not be limited in the present disclosure.

The relevant information of user accounts (including social relationship identity information and the like) described in the embodiments of the disclosure are obtained under user permission. On the premise of obtaining user permission and authorization, the method, apparatus, device and storage medium involved in the disclosure can obtain the relevant information of users.

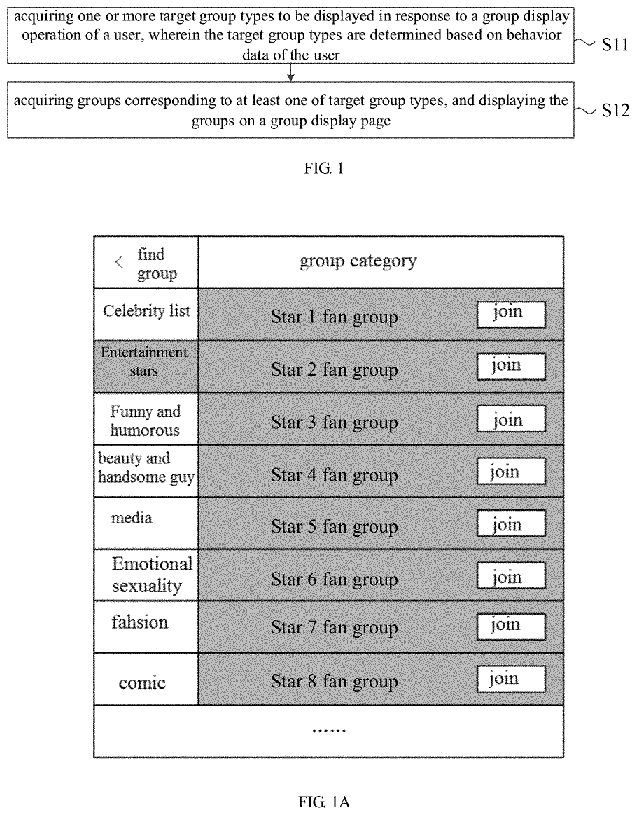

The present disclosure provides a method for displaying groups, as shown in FIG. 1. FIG. 1 is a flowchart of a method for displaying groups according to an embodiment of the present disclosure. Referring to FIG. 1, the method for displaying groups provided by the present disclosure includes the following blocks.

At block S11, one or more target group types to be displayed are acquired in response to a group display operation of a user. The target group types are determined based on behavior data of the user.

In some embodiments, an execution subject of the method for displaying groups may be a terminal. A user may install application software on the terminal and browse a plurality of pages displayed by the application software to the user through the user registered on the application software. During a process of browsing the pages by the user, the behavior data may be generated, and the terminal may record the behavior data generated by the user in real time. These behavior data may be, for example, data related to a page when the user accesses the page, data related to works visited by the user, data related to works published by the user, etc., which will not be limited in the disclosure. The target group type may be acquired by analyzing the behavior data of the user. The target group type represents a group type interested by the user. For example, when the user is determined to be interested in a game by analyzing the behavior data, the target group type may be the game.

In the block S11, a timing of the act of determining the target group type may be either when the group display operation of the user is triggered or before the group display operation of the user is triggered. The specific setting may be based on actual requirements, which is not limited in the present disclosure. An implementation of the act of determining the target group type may be by clicking a virtual button which is set in the page and indicates a request to display the groups. The virtual button may be a link (for example, a link displayed as “more groups>”), a picture or other symbols, etc., which is not limited in the present disclosure.

At block S12, groups corresponding to at least one of the target group types are acquired, and the groups are displayed on a group display page.

In some embodiments, each group type corresponds to a plurality of groups. For example, when the group type is the game, there may be a plurality of groups related to the game, and when the group type is a star, there may be a plurality of groups related to the star. The number of the target group types may be one or more. For each target group type, the plurality of groups corresponding to the target group type may be selected and the selected groups may be displayed on the group display page. The way to display the groups on the group display page may be as follows: displaying the one or more target group types to be displayed in a left region of the group display page; when a certain target group type is clicked by the user, displaying the groups corresponding to the target group type in a right region of the group display page; alternatively, displaying a list of group types in the left region of the group display page, and displaying the target group type at the top of the list of group types, accordingly, when a certain target group type is clicked by the user, displaying the target groups corresponding to the target group type in the right region of the group display page. As shown in FIG. 1A, FIG. 1A is a schematic diagram of a result of group display according to an embodiment of the present disclosure. The specific way to display the target groups may be set according to actual requirements, which is not limited in the disclosure.

In the block S12, when there are more than one groups in accord with at least one of the target group types, the degree of interest of the user for different target groups may be further determined according to the behavior data of the user. Further, a preset number of the target groups may be selected and displayed according to the degree of interest, and the display of the remaining target groups may be determined according to requirements of the user. For example, when a next page is clicked under the user, another preset number of the target groups may be selected and displayed according to the degree of interest from the remaining target groups.

In an embodiment of the present disclosure, when detecting the group display operation triggered by the user, first the one or more target group types to be displayed are acquired in response to the operation, the target group types are determined according to the behavior data of the user, and then the groups corresponding to at least one of the target group types are acquired and the groups are displayed on the group display page. An embodiment of the present disclosure obtains the one or more target group types to be displayed that the user is interested in according to the behavior data generated by the user, and acquires the groups from the target group type and displays the groups to the user. Therefore, the user may quickly find the groups satisfying social requirements without searching in a large number of groups, to realize social networking, which may greatly reduce time cost of social of the user and improve social experience of the user.

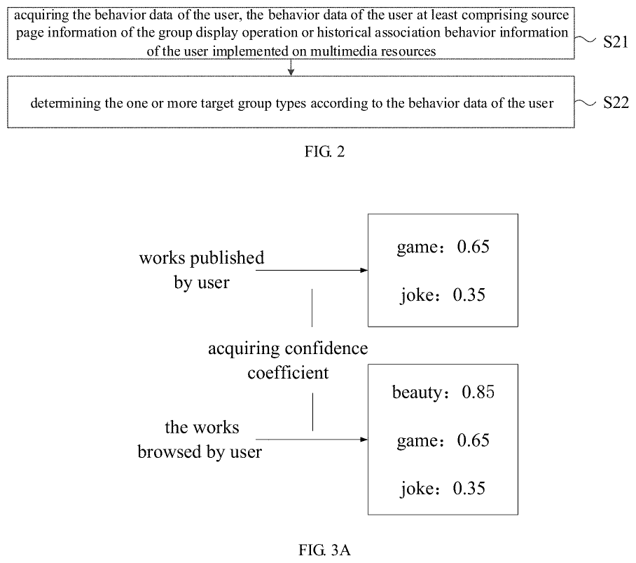

Combined with the above embodiment, in an embodiment, an embodiment of the present disclosure also provides a method for determining the one or more target group types, as illustrated in FIG. 2. FIG. 2 is a flowchart of a method for determining one or more target group types according to an embodiment of the present disclosure. Referring to FIG. 2, the method may include the following blocks.

At block S21, the behavior data of the user is acquired. The behavior data of the user at least includes source page information of the group display operation or historical association behavior information of the user implemented on multimedia resources.

In some embodiments, the source page information of the group display operation may include contents displayed on a source page, browsed contents of the user on the source page, a duration of each of the browsed contents of the user on the source page, etc. The disclosure will not make limitations on the source page information. The historical association behavior information of the user implemented on multimedia resources may include information of published works of the user and information of browsed works of the user.

At block S22, the one or more target group types are determined according to the behavior data of the user.

In some embodiments, by analyzing the behavior data of the user, the group type that the user is interested in may be acquired, and then the group type may be determined as the target group type.

By analyzing the behavior data of the user, it may be determined the target group type that the user is interested in, thus displaying the groups with targeted to the user, helping the user to find groups satisfying social requirements faster, effectively reducing the time cost of the social of the user and improving the social experience of the user.

Combined with the above embodiments, in an embodiment, the behavior data of the user may include the historical association behavior information of the user implemented on the multimedia resources, and the block S22 may include:

determining works involved in the historical association behavior information of the user implemented on the multimedia resources within a preset historical period;

acquiring group tags carried by the works;

determining a confidence coefficient of the user for each type of group tag, in which the confidence coefficient is configured to characterize a degree of interest of the user; and

determining the target group type according to the confidence coefficient for each type of group tag.

In some embodiments, first the historical association behavior information of the user implemented on the multimedia resources within the preset historical period is acquired. The historical association behavior information is analyzed, and the related works and the group tag carried by each work are acquired. There are many ways to obtain the group tag, which will be described below. Then, the confidence coefficient of the user for each type of group tag may be determined according to the group tags of all works. There are many ways to determine the confidence coefficient, which will be described below. The confidence coefficient is configured to characterize the degree of interest of the user in the group type corresponding to each type of group tag. Finally, the target group type may be determined according to the confidence coefficients of all group tags. For example, a group type corresponding to a group tag with the highest confidence coefficient may be determined as the target group type, or a group type corresponding to a group tag with the confidence coefficient greater than a preset threshold may be determined as the target group type.

In some embodiments, there is provided a way to determine the target group type that the user is interested in by analyzing the historical association behavior information of the user implemented on the multimedia resource, thus displaying the groups with targeted to the user, helping the user to find groups satisfying the social requirements faster, effectively reducing the time cost of the social of the user and improving the social experience of the user.

Combined with the above embodiments, in an embodiment, determining the target group type according to the confidence coefficient for each type of group tag may include:

determining a group type corresponding to a group tag with the confidence coefficient greater than a preset threshold as the target group type;

on this basis, the block S12 may include:

selecting the groups based on each target group type, and displaying the groups on the group display page in an order of confidence coefficients corresponding to respective target group types from high to low.

In some embodiments, after determining the target group type, a preset number of groups may be selected from each target group type, and then these groups may be displayed on the group display page in the order of the confidence coefficients corresponding to respective target group types from high to low. For example, the target group types include “game”, “food” and “travel”, and the corresponding confidence coefficients are 0.3, 0.4 and 0.2 respectively, 10 groups may be selected from each of “game”, “food” and “travel”, to display on the group display page in an order of groups corresponding to “food”, groups corresponding to “game” and groups corresponding to “travel”.

In some embodiments, there is provided a way to display the target groups, which may include directly acquiring the groups corresponding to the target group type and displaying the groups on the group display page, which may help the user find the groups satisfying the social requirements faster and effectively reduce the time cost of the user.

Combined with the above embodiments, in an embodiment, the present disclosure also provides another way to display the target groups. Specifically, the block S12 may include:

displaying group types corresponding to respective group tags on the group display page in an order of the confidence coefficients corresponding to respective group tags from high to low; and

acquiring the groups based on a group type with the confidence coefficient greater than a preset threshold, and displaying the groups in a designated region of the group display page.

In some embodiments, the group types corresponding to respective group tags may be displayed on the group display page in the order of the confidence coefficients from high to low, and then top group types (that is, each group type with the confidence coefficient greater than the preset threshold) may be determined as the target group types. When a certain target group type is clicked by the user, the groups corresponding to the group type are acquired and displayed in the designated region of the group display page. For example, a list of group types may be displayed in a left region of the group display page. The list of group types may include the group types corresponding to respective group tags, and the target group types are displayed at the top of the list of group types. The target groups corresponding to the first one of the target group types are displayed in a region on the right of the list of group types by default. When any another target group type is clicked by the user, the target groups corresponding to the target group type are displayed in the region on the right of the list of group types.

In some embodiments, there is provided another way to display the target groups, which may include displaying the group types corresponding to respective group tags on the group display page in the order of the confidence coefficients from high to low, the group type with the confidence coefficient greater than the preset threshold is determined as the target group type, and then the target groups is selected according to the target group type for display, which may help the user find the groups satisfying the social requirements faster and effectively reduce the time cost of the user.

Combined with the above embodiments, in an embodiment, the present disclosure also provides a method for determining the confidence coefficient, which may include:

counting a number of group tags for each type and a total number of all group tags; and

acquiring the confidence coefficient for each type of group tag based on a quotient value of the number of group tags for each type and the total number of all group tags. The quotient value may be determined as the confidence coefficient.

In some embodiments, after obtaining the group tags carried by the works, the total number of all group tags and the number of group tags for each type may be acquired. The number of group tags for each type is divided by the total number of all group tags, to obtain the quotient value which is used as the corresponding confidence coefficient. For example, all types of group tags may include “music”, “game”, “food”, “star” and “travel”. The number of group tags for each type is 10, 25, 5, 30, 20 and 10, respectively, and the total number of group tags is 100, so the confidence coefficients obtained are 0.1, 0.25, 0.05, 0.3, 0.2 and 0.1 respectively.

With dividing the number of group tags for each type by the total number of all types of group tags, the confidence coefficient for each type of group tag may be obtained, which may effectively obtain the degree of interest of the user in the group type corresponding to each type of group tag, further select the target group type.

Combined with the above embodiments, in an embodiment, the historical association behavior information may include information of published works and information of browsed works. On this basis, the present disclosure also provides another method for determining the confidence coefficient, which may include:

determining published works of the user within the preset historical period according to information of the published works of the user within the preset historical period;

acquiring group tags carried by the published works;

determining a first confidence coefficient of the user for each type of group tag based on the group tags carried by the published works;

determining browsed works of the user within the preset historical period according to information of the browsed works of the user within the preset historical period; and

acquiring group tags carried by the browsed works;

determining a second confidence coefficient of the user for each type of group tag based on the group tags carried by the browsed works; and

acquiring the confidence coefficient of the user for each type of group tag by weighting the first confidence coefficient and the second confidence coefficient.

In some embodiments, the historical association behavior information may be divided into the information of the published works and the information of the browsed works. The first confidence coefficient is acquired for the information of the published works, and the second confidence coefficient is acquired for the information of the browsed works. The process of acquiring the first confidence coefficient and the process of acquiring the second confidence coefficient may refer to the method of acquiring the confidence coefficient in the aforementioned embodiment, which will not be repeated here. Finally, the confidence coefficient of the user for each type of group tag may be acquired by weighting the first confidence coefficient and the second confidence coefficient according to a preset weight proportion.

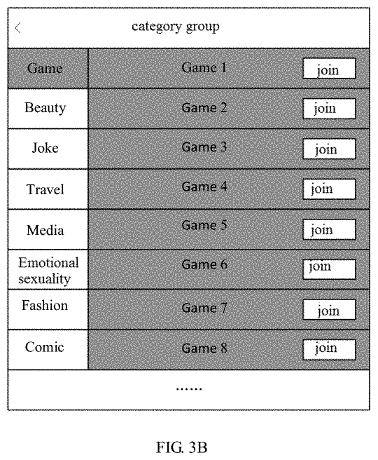

FIG. 3A is a schematic diagram of acquiring a confidence coefficient for a group tag according to an embodiment of the present disclosure. In FIG. 3A, for the works published by the user, based on the above method of acquiring the confidence coefficient, a confidence coefficient for a group tag “game” is 0.65, and a confidence coefficient for a group tag “joke” is 0.35. For the works browsed by the user, based on the above method of acquiring the confidence coefficient, a confidence coefficient for a group tag “beauty” is 0.85, a confidence coefficient for the group tag “game” is 0.65, and the confidence coefficient for the group tag “joke” is 0.35. In a case that the preset weight proportion is 1:1, the confidence coefficients of respective group tags are that “game” 1.3, “joke” 0.7, “beauty” 0.85. Finally, the result of displaying the target group according to the confidence coefficients may be shown in FIG. 3B, which is a schematic diagram illustrating another result of group display according to an embodiment of the present disclosure.

The historical association behavior information is divided into different types, and the confidence coefficients of each type of group tag are acquired. The different confidence coefficients are weighted to obtain the final confidence coefficient of the user for each type of group tag. Considering an impact of different types of historical association behavior information on the degree of interest of the user, the confidence coefficients that reflect the true degree of interest of the user may be obtained more accurately, so as to better select the target group type.

Combined with the above embodiments, in an embodiment, the present disclosure also provides a method for acquiring group tags carried by the works, which may include:

acquiring the group tag of each work according to a tag carried by the work itself, the tag carried by the work is labeled by an author of the work according to tags in a pre-provided tag set when the work is published.

In some embodiments, the tag set may be formed by tags acquitted by manually dividing and summarizing according to collected content data in advance. The specific process may be as follows: collecting a large number of works having published on a platform as samples; extracting a key frame for each work as a sample; acquiring corresponding content feature words by analyzing with an existing image content algorithm to obtain the corresponding content feature words; combining the content feature words with words obtained by word segmentation with the title and description of the work to form a set of feature words, thus acquiring the set of feature words of each sample; finally, based on the sets of feature words of all samples, counting a frequency proportion of each feature word, and selecting the top N feature words in the order of the frequency proportions as the tags to form a tag set. In this way, when publishing the work, each user may obtain the tags from the tag set to label the work.

Combined with the above embodiments, in an embodiment, the present disclosure also provides another method for obtaining group tags carried by works, which may include:

acquiring a set of feature words of the works, wherein the set of feature words at least includes content feature words, title segmentation and description information segmentation; and

acquiring the group tags carried by the works by inputting the set of feature words into a pre-trained group tag classification model, in which the group tag classification model is acquired by training a preset model using a set of feature words of published works as training samples.

In some embodiments, the process of obtaining the set of feature words of the work may be referred to the above. When training the group tag classification model, the set of feature words, as the training samples, is formed by collecting a large number of published works. Validation samples corresponding to different tags are manually set. Based on the training samples and the verification samples, the group tag classification model is obtained by training through machine learning algorithm or neural network.

Predicting the group tags carried by the works through the group tag classification model may improve accuracy of the obtained group tags, so as to further obtain the group types that the user is interested in.

Combined with the above embodiments, in an embodiment, the behavior data of the user may be the source page information of the group display operation. On this basis, the present disclosure also provides another method for determining the target group type, which may include:

acquiring a group tag carried by a source page of the group display operation according to the source page information of the group display operation; and

determining the target group type based on the group type corresponding to the group tag.

In some embodiments, a group tag may be added to each page including a group display entry (the group display entry is configured to trigger the group display operation of the user) in advance. For example, when a content displayed on a certain page is a game, a group tag of “game” may be added to the page, and the “game” may be directly determined as the target group type when the group display operation of the user is triggered on the page.

There are a plurality of types of group tags added to the page. For example, when the content displayed on a certain page is game and music, then the group tags of “games” and “music” may be added to this page. When the group display operation of the user is triggered on the page, “game” and “music” may be directly determined as the target group types.

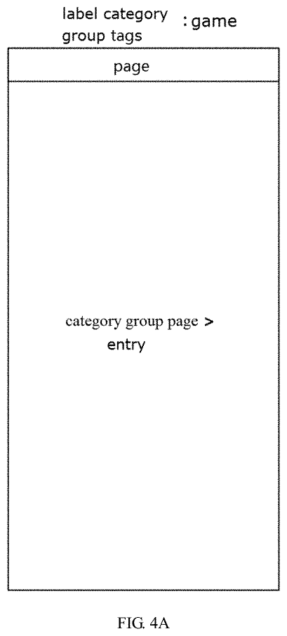

FIG. 4A is a schematic diagram of labeling a group tag according to an embodiment of the present disclosure. FIG. 4B is a schematic diagram of acquiring a group tag according to an embodiment of the present disclosure. FIG. 4C is a schematic diagram illustrating another result of group display according to an embodiment of the present disclosure. In FIGS. 4A-4C, a category group refers to the group, a category group page entry refers to the group display entry, and a category group tag refers to the group tag. When the user browses a certain page (the page is pre-labeled with a category group tag called “game”), clicks the category group page entry in the page, a terminal automatically acquires the category group tag “game” in the page, then sets the group type corresponding to the tag “game” to the top, and finally displays “game” at the top of the category group page. Therefore, the user may quickly find the category group related to the game.

The group tag carried by the source page is obtained through the information of the source page of the group display operation. Considering that the content of the source page usually represents the content that the user is recently interested in, the group type corresponding to the group tag carried by the source page is determined as the target group type, which widens a channel to explore the group type interested by the user, and helps the user find the groups satisfying the social requirements faster and effectively reduces the time cost of the user.

Combined with the above embodiments, in an embodiment, the block S21 may include:

displaying the target group type on top of the group display page, in which the group type corresponding to each type of group tag is displayed on the group display page; and

acquiring the groups corresponding to the target group type, and displaying the groups in a designated region of the group display page.

In some embodiments, after obtaining the target group type, the target group type may be displayed on the top of the group display page. The detailed process of obtaining and displaying the groups corresponding to the target group type may refer to the above, which will not be repeated herein.

Displaying the target group type on the top may display the groups with targeted to the user, help the user to find groups satisfying social requirements faster, effectively reduce the time cost of the social of the user.

Combined with the above embodiments, in an embodiment, acquiring the group tag carried by the source page of the group display operation according to the source page information of the group display operation includes:

acquiring, according to a browsing history of the user on the source page, the group tag and a plurality of types of sub-tags corresponding to the group tag;

after determining the group type corresponding to the group tag as the target group type, the method further includes:

determining a confidence coefficient of the user for each type of sub-tag;

said acquiring the target groups corresponding to at least one of the target group types, and displaying the groups on the group display page includes:

acquiring groups corresponding to at least one of the target group types and in accord with respective types of sub-tags; and

displaying the groups in a designated region of the group display page in an order of confidence coefficients for respective types of sub-tags from high to low.

In some embodiments, each type of group tag may correspond to a plurality of types of sub-tags. For example, the sub-tags of the group tag “game” may respectively be “leisure puzzle”, “role play”, “shooting”, “chess and cards”, etc. According to the browsing history of the user on the source page, the browsing duration of the user for respective types of games may be acquired, and the degree of interest of the user in respective types of games may be determined according to the browsing duration. Determining the confidence coefficient of the user for each type of sub-tag may include: determining the confidence coefficient for each type of sub-tag according to the browsing duration of the user for each type of games, and acquiring the confidence coefficient of the user for each type of sub-tag by dividing the browsing duration of the user for each type of games by a total browsing duration of the user for all types of games.

After obtaining each type of sub-tag of the target group type, the groups corresponding to each type of sub-tag may be selected in the order of the confidence coefficient of respective types of sub-tags from high to low, and displayed in the designated region of the group display page. The specific display method may refer to the above, and this disclosure will not be repeated herein.

The group type is divided into the plurality of types of sub-tags, and the confidence coefficient of each type of sub-tag is acquired, which may more accurately acquire the groups interested by the user, help the user to find groups satisfying social requirements faster, effectively reduce the time cost of the social of the user.

In some embodiments, the method for displaying groups may include:

acquiring the behavior data of the user, the behavior data of the user at least including source page information of the group display operation or historical association behavior information of the user implemented on multimedia resources;

sending the behavior data of the user to a server, in which the server is configured to determine the one or more target group types according to the behavior data of the user; and

receiving the one or more target group types returned by the server.

In some embodiments, the process of determining the one or more target group types may be performed in the server. After obtaining the behavior data of the user, the terminal may send the behavior data of the user to the server, and the server may return the one or more target group types to the terminal after determining the one or more target group types, to enable the terminal to display the target groups according to the one or more target group types.

Performing the process of determining the one or more target group types in the server may reduce requirements for a computing power of the terminal, such that the method for displaying groups of the present disclosure may be implemented in some terminal devices with low configuration, widen a implementation channel of the method for displaying groups of the present disclosure, and better meets the social requirements of the user.

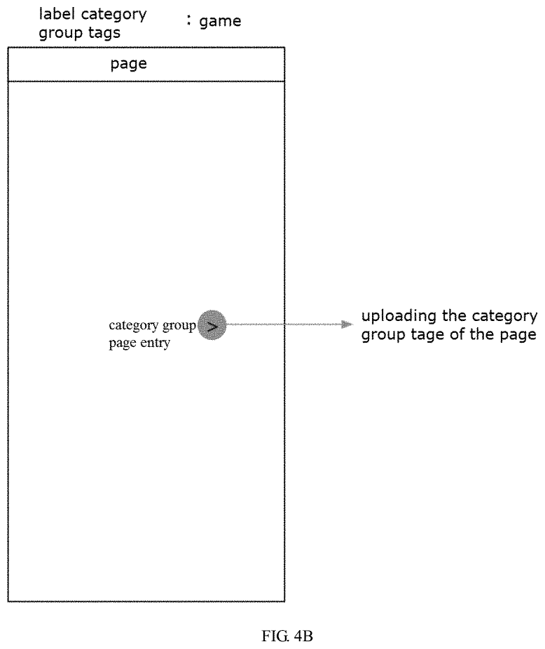

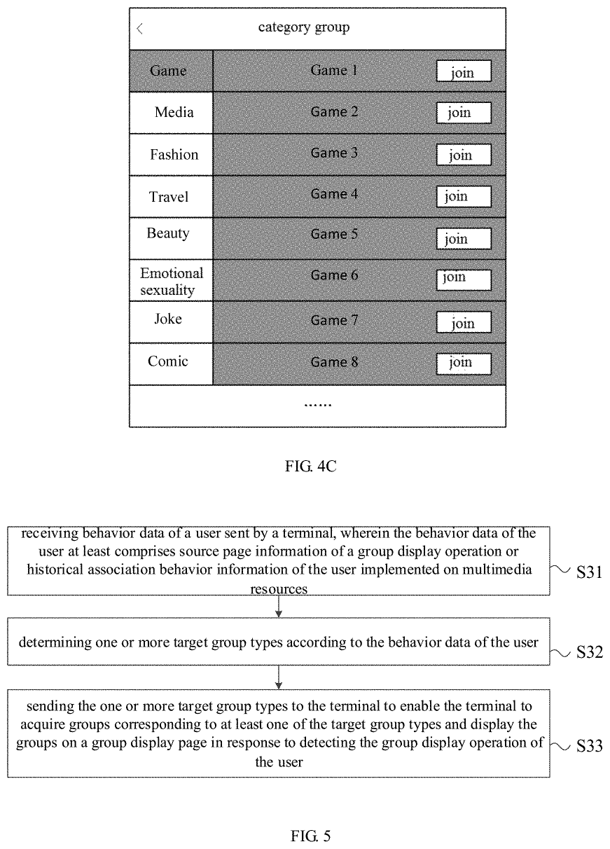

The present disclosure first provides a method for displaying groups, as shown in FIG. 5. FIG. 5 is a flowchart of another method for displaying groups according to an embodiment of the present disclosure. Referring to FIG. 6, the method for displaying groups provided by the present disclosure includes the following blocks.

At block S31, behavior data of a user sent by a terminal is received. The behavior data of the user at least includes source page information of a group display operation or historical association behavior information of the user implemented on multimedia resources.

At block S32, one or more target group types are determined according to the behavior data of the user; and

At block S33, the one or more target group types are sent to the terminal to enable the terminal to acquire groups corresponding to at least one of the target group types and display the groups on a group display page in response to detecting the group display operation of the user.

In some embodiments, the execution subject of the method for displaying groups may be a server. For the specific process of the server executing the method for displaying groups, please refer to the process of the terminal executing the method for displaying groups in the foregoing, and this disclosure will not be repeated here.

Combined with the above embodiments, in an embodiment, the behavior data of the user includes the historical association behavior information of the user implemented on the multimedia resources, said determining the one or more target group types according to the behavior data of the user includes:

determining works involved in the historical association behavior information of the user within a preset historical period;

acquiring group tags carried by the works;

determining a confidence coefficient of the user for each type of group tag, wherein the confidence coefficient is configured to characterize a degree of interest of the user; and

determining the target group type according to the confidence coefficient for each type of group tag.

In some embodiments, the specific process of determining the target group type according to the historical association behavior information of the user implemented on the multimedia resources may be referred to the foregoing and will not be repeated herein.

Combined with the above embodiments, in an embodiment, determining the confidence coefficient of the user for each type of group tag includes:

counting a number of group tags for each type and a total number of all group tags; and

acquiring the confidence coefficient for each type of group tag based on a quotient value of the number of group tags for each type and the total number of all group tags.

In some embodiments, the specific process of determining the confidence coefficient of the user for each type of group tag may be referred to the foregoing and will not be repeated herein.

Combined with the above embodiments, in an embodiment, the historical association behavior information includes information of published works and information of browsed works;

determining the confidence coefficient of the user for each type of group tag includes:

determining published works of the user within the preset historical period according to information of the published works of the user within the preset historical period;

acquiring group tags carried by the published works;

determining a first confidence coefficient for each type of group tag for the user based on the group tags carried by the published works;

determining browsed works of the user within the preset historical period according to information of the browsed works of the user within the preset historical period;

acquiring group tags carried by the browsed works;

determining a second confidence coefficient for each type of group tag for the user based on the group tags carried by the browsed works; and

acquiring the confidence coefficient of the user for each type of group tag by weighting the first confidence coefficient and the second confidence coefficient.

Combined with the above embodiments, in an embodiment, acquiring the group tags carried by the works includes:

acquiring a set of feature words of the works, in which the set of feature words at least includes content feature words, title segmentation and description information segmentation; and

acquiring the group tags carried by the works by inputting the set of feature words into a pre-trained group tag classification model, wherein the group tag classification model is acquired by training a preset model using a set of feature words of published works as training samples.

In some embodiments, the behavior data of the user is the source page information of the group display operation, determining the one or more target group types according to the behavior data of the user includes:

acquiring a group tag carried by a source page of the group display operation according to the source page information of the group display operation; and

determining the target group type based on the group type corresponding to the group tag.

Combined with the above embodiments, in an embodiment, acquiring the group tag carried by the source page of the group display operation according to the source page information of the group display operation includes:

acquiring, according to a browsing history of the user on the source page, the group tag and a plurality of types of sub-tags corresponding to the group tag;

the method further includes:

determining a confidence coefficient of the user for each type of the sub-tag;

in which, sending the one or more target group types to the terminal includes:

sending the one or more target group types and the confidence coefficient of each type of sub-tag to the terminal, to enable the terminal to acquire groups corresponding to the at least one of target group types and in accord with respective types of sub-tags and display the groups in a designated region of the group display page in an order of confidence coefficients for the respective types of the sub-tags from high to low in response to detecting the group display operation of the user.

Based on the similar concept, an embodiment of the present disclosure provides an apparatus 600 for displaying groups. Referring to FIG. 6, FIG. 6 is a block diagram of an apparatus for displaying groups according to an embodiment of the present disclosure. As shown in FIG. 6, the apparatus 600 for displaying groups includes:

a first acquiring module 601, configured to acquire one or more target group types to be displayed in response to a triggered group display operation of a user, in which the target group types are determined based on behavior data of the user; and

a second acquiring module 602, configured to acquire groups corresponding to at least one of the target group types, and display the groups on a group display page.

In some embodiments, the apparatus 600 for displaying groups further includes:

a third acquiring module, configured to acquire the behavior data of the user, the behavior data of the user at least comprising source page information of the group display operation or historical association behavior information of the user implemented on multimedia resources; and

a first determining module, configured to determine the one or more target group types according to the behavior data of the user.

In some embodiments, the behavior data of the user includes the historical association behavior information of the user implemented on the multimedia resources. The first determining module includes:

a first determining sub-module, configured to determine works involved in the historical association behavior information of the user implemented on the multimedia resources within a preset historical period;

a first obtaining module, configured to obtain group tags carried by the works;

a second determining sub-module, configured to determine a confidence coefficient of the user for each type of group tag, wherein the confidence coefficient is configured to characterize a degree of interest of the user; and

a third determining sub-module, configured to determine the target group type according to the confidence coefficient for each type of group tag.

In some embodiments, the third determining sub-module includes:

a fourth determining sub-module, configured to determine the target group type based on a group type corresponding to a group tag with the confidence coefficient greater than a preset threshold;

the second acquiring module 602 includes:

a first display module, configured to select the groups based on each target group type, and display the groups on the group display page in an order of confidence coefficients corresponding to respective target group types from high to low.

In some embodiments, the second acquiring module 602 includes:

a second display module, configured to display group types corresponding to respective group tags on the group display page in an order of the confidence coefficients corresponding to respective group tags from high to low; and

a third display module, configured to acquire the groups based on a group type with the confidence coefficient greater than a preset threshold, and display the groups in a designated region of the group display page.

In some embodiments, the second determining sub-module includes:

a first counting module, configured to count a number of group tags for each type and a total number of all group tags; and

a fifth determining sub-module, configured to acquire the confidence coefficient for each type of group tag based on a quotient value of the number of group tags for each type and the total number of all group tags.

In some embodiments, the historical association behavior information includes information of published works and information of browsed works;

the second determining sub-module includes:

a sixth determining sub-module, configured to determine published works of the user within the preset historical period according to information of the published works of the user within the preset historical period;

a second obtaining module, configured to obtain group tags carried by the published works;

a seventh determining sub-module, configured to determine a first confidence coefficient of the user for each type of group tag based on the group tags carried by the published works;

an eighth determining sub-module, configured to determine browsed works of the user within the preset historical period according to information of the browsed works of the user within the preset historical period; and

a third obtaining module, configured to obtain group tags carried by the browsed works;

a ninth determining sub-module, configured to determine a second confidence coefficient of the user for each type of group tag based on the group tags carried by the browsed works; and

a fourth obtaining module, configured to obtain the confidence coefficient of the user for each type of group tag by weighting the first confidence coefficient and the second confidence coefficient.

In some embodiments, the first obtaining module includes:

a first obtaining sub-module, configured to obtain a set of feature words of the works, wherein the set of feature words at least comprises content feature words, title segmentation and description information segmentation; and

an input module, configured to acquire the group tags carried by the works by inputting the set of feature words into a pre-trained group tag classification model, in which the group tag classification model is acquired by training a preset model using a set of feature words of published works as training samples.

In some embodiments, the behavior data of the user is the source page information of the group display operation, the first determining module includes:

a fifth obtaining module, configured to obtain a group tag carried by a source page of the group display operation according to the source page information of the group display operation; and

a ten determining sub-module, configured to determine the target group type based on the group type corresponding to the group tag.

In some embodiments, the second acquiring module 602 includes:

a fourth display module, configured to display the target group type on top of the group display page, in which the group type corresponding to each type of group tag is displayed on the group display page; and

a fifth display module, configured to acquire the groups corresponding to the target group type, and display the groups in a designated region of the group display page.

In some embodiments, the fifth acquiring module includes:

a second obtaining sub-module, configured to obtain, according to a browsing history of the user on the source page, the group tag and a plurality of types of sub-tags corresponding to the group tag;

the apparatus 600 for displaying groups further includes:

a second determining module, configured to determine a confidence coefficient of the user for each type of sub-tag;

the second acquiring module 602 includes:

a sixth display module, configured to acquire groups corresponding to at least one of the target group types and in accord with respective types of sub-tags, and display the groups in a designated region of the group display page in an order of confidence coefficients for respective types of the sub-tags from high to low.

In some embodiments, the apparatus 600 for displaying groups further includes:

a fourth acquiring module, configured to acquire the behavior data of the user, the behavior data of the user at least comprising source page information of the group display operation or historical association behavior information of the user implemented on multimedia resources;

a first sending module, configured to send the behavior data of the user to a server, wherein the server is configured to determine the one or more target group types according to the behavior data of the user; and

a first receiving module, configured to receive the one or more target group types returned by the server.

An embodiment of the present disclosure provides a terminal, including:

processor; and

a memory for storing executable instructions of the processor;

in which, the processor is configured to perform acts for implementing the method for displaying groups according to any one of embodiments of the present disclosure.

An embodiment of the present disclosure provides a non-transitory computer-readable storage medium. When instructions are executed by a processor of a terminal, the terminal is caused to perform acts for implementing the method for displaying groups according to any one of embodiments of the present disclosure.

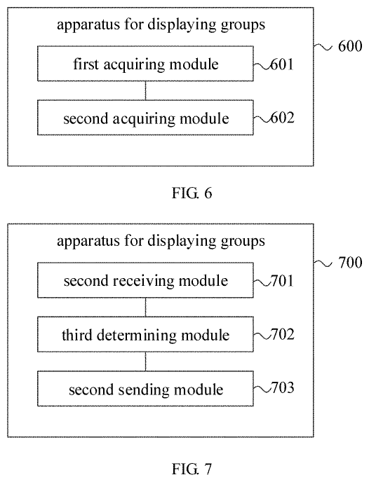

Based on the similar concept, an embodiment of the present disclosure provides an apparatus 700 for displaying groups. Referring to FIG. 7, FIG. 7 is a block diagram of another apparatus for displaying groups according to an embodiment of the present disclosure. As shown in FIG. 7, the apparatus 700 for displaying groups includes:

a second receiving module 701, configured to receive behavior data of a user sent by a terminal, the behavior data of the user at least comprising source page information of a group display operation or historical association behavior information of the user implemented on multimedia resources;

a third determining module 702, configured to determine one or more target group types according to the behavior data of the user; and

a second sending module 703, configured to send the one or more target group types to the terminal to enable the terminal to acquire groups corresponding to at least one of the target group types and display the groups on a group display page in response to detecting the group display operation of the user.

In some embodiments, the behavior data of the user includes the historical association behavior information of the user implemented on the multimedia resources, the third determining module 702 includes:

an eleventh determination sub-module, configured to determine works involved in the historical association behavior information of the user within a preset historical period;

a sixth obtaining module, configured to obtain group tags carried by the works;

a twelfth determining sub-module, configured to determine a confidence coefficient of the user for each type of group tag, wherein the confidence coefficient is configured to characterize a degree of interest of the user; and

a thirteenth determining sub-module, configured to determine the target group type according to the confidence coefficient for each type of group tag.

In some embodiments, the twelfth determination sub-module includes:

a second counting module, configured to count a number of group tags for each type and a total number of all group tags; and

a fourteenth determining sub-module, configured to acquire the confidence coefficient for each type of group tag based on a quotient value of the number of group tags for each type and the total number of all group tags.

In some embodiments, the historical association behavior information comprises information of published works and information of browsed works;

the twelfth determination sub-module includes:

a fifteenth determining sub-module, configured to determine published works of the user within the preset historical period according to information of the published works of the user within the preset historical period;

a seventh obtaining module, configured to obtain group tags carried by the published works;

a sixteenth determining sub-module, configured to determine a first confidence coefficient for each type of group tag for the user based on the group tags carried by the published works;

a seventeenth determining sub-module, configured to determine browsed works of the user within the preset historical period according to information of the browsed works of the user within the preset historical period;

an eighth obtaining module, configured to obtain group tags carried by the browsed works;

an eighteenth determining sub-module, configured to determine a second confidence coefficient for each type of group tag for the user based on the group tags carried by the browsed works; and

a ninth obtaining module, configured to obtain the confidence coefficient of the user for each type of group tag by weighting the first confidence coefficient and the second confidence coefficient.

In some embodiments, the sixth obtaining module includes:

a third obtaining sub-module, configured to obtain a set of feature words of the works, wherein the set of feature words at least comprises content feature words, title segmentation and description information segmentation; and

a fourth obtaining sub-module, configured to obtain the group tags carried by the works by inputting the set of feature words into a pre-trained group tag classification model, wherein the group tag classification model is acquired by training a preset model using a set of feature words of published works as training samples.

In some embodiments, the third determining module includes:

a tenth obtaining module, configured to obtain a group tag carried by a source page of the group display operation according to the source page information of the group display operation; and

a nineteenth determining sub-module, configured to determine the target group type based on the group type corresponding to the group tag.

In some embodiments, the tenth obtaining module includes:

a fifth obtaining sub-module, configured to obtain, according to a browsing history of the user on the source page, the group tag and a plurality of types of sub-tags corresponding to the group tag;

the apparatus 700 for displaying groups includes:

a fourth determining module, configured to determine a confidence coefficient of the user for each type of the sub-tag;

the second sending module includes:

a sending sub-module, configured to send the one or more target group types and the confidence coefficient of each type of sub-tag to the terminal, to enable the terminal to acquire groups corresponding to at least one of the target group types and in accord with respective types of sub-tags and display the groups in a designated region of the group display page in an order of confidence coefficients for the respective types of the sub-tags from high to low in response to detecting the group display operation of the user.

An embodiment of the present disclosure provides a server, including:

a processor; and

a memory for storing executable instructions of the processor;

in which, the processor is configured to perform acts for implementing the method for displaying groups according to any one of embodiments of the present disclosure.

An embodiment of the present disclosure provides a non-transitory computer-readable storage medium. When instructions are executed by a processor of a server, the server is caused to perform acts for implementing the method for displaying groups according to any one of embodiments of the present disclosure.

The disclosure also provides a system for displaying groups including a terminal and a server.

The terminal is configure to acquire the behavior data of the user, the behavior data of the user at least includes source page information of the group display operation or historical association behavior information of the user implemented on multimedia resources, send the behavior data of the user to the server, and receive the target group type returned by the server.

The server is configure to, receive behavior data of a user sent by the terminal, determine one or more target group types according to the behavior data of the user, and send the one or more target group types to the terminal.

For example, the user logs in to social software A through a mobile phone and browses works published by other users through the social software A. In a process of browsing of the user, the social software A obtains the behavior data generated by the user in real time, for example, time information of the user browsing a work (including a time point for clicking, a duration for browsing, etc.) and information of the work (including author information, work content, publishing time, etc.), Then, the behavior data is sent to a background server of the social software A in real time (it may also be an independent third-party platform, which is not specifically limited in the disclosure), and the background server stores the behavior data. When detecting that the user has triggered a group display operation on a page, the social software A sends a request for acquiring target groups to the background server. After receiving the request, the background server obtains the behavior data within a preset historical period and analyzes the behavior data, determines the one or more target group types to be displayed (the specific process of determining the one or more target group types according to the behavior data may refer to the above) and the target groups corresponding to at least one of the target group types, and then sends at least one of the target group types and the target groups corresponding to at least one of the target group types to a front-end of the social software A, so that the social software A displays the target groups on the group display page of the front-end. Therefore, the user may find and join the groups they are interested in.

In the above process, after obtaining the behavior data, the background server may also analyze the behavior data in the historical period in advance to determine the one or more target group types to be displayed and the target groups corresponding to at least one of the target group types. After receiving the request for acquiring the target groups sent by the social software A, the background server may directly send the one or more target group types to be displayed and the target groups corresponding to at least one of the target group types to the front end of the social software A.

Secondly, in the above process, the social software A may also store the behavior data locally. When detecting that the user has triggered the group display operation on the page, the social software A may obtain the behavior data within the preset historical period, send the request for acquiring the target groups carried with the behavior data to the background server, such that the background server analyzes the behavior data, determines the one or more target group types to be displayed and the target groups corresponding to at least one of the target group types, and sends the one or more target group types to be displayed and the target groups to the front end of the social software A.

In some embodiments, the terminal and the server may cooperate to complete the display of the target groups in any of the various implementations described above. However not all the ways are listed, and the specific settings may be set according to the actual requirements, which will not be limited in the present disclosure.

An embodiment of the present disclosure provides a system for displaying groups, including a terminal capable of performing acts for implementing the method for displaying groups according to the first aspect of the present disclosure and a server capable of performing acts for implementing the method for displaying groups according to the second aspect of the present disclosure.

As for the apparatus embodiments, it is basically similar to the method embodiments, so the description is relatively simple. Please refer to the partial description of the method embodiment for relevant parts.

Various embodiments in this specification are described in a progressive manner. Each embodiment focuses on the differences from other embodiments. The same and similar parts between the embodiments can be referred to each other.

Those skilled in the art should understand that embodiments of the present disclosure may be provided as methods, devices, or computer program products. Therefore, the embodiments of the present disclosure may take the form of full hardware embodiments, full software embodiments, or embodiments combining software and hardware. Moreover, the embodiments of the present disclosure may take the form of computer program products implemented on one or more computer usable storage medium (including but not limited to a disk memory, a CD-ROM, an optical memory, etc.) containing computer usable program codes.

Embodiments of the present disclosure are described with reference to flow charts and/or block diagrams of methods, terminal devices (systems), and computer program products according to embodiments of the present disclosure. It should be understood that each flow and/or block in the flow chart and/or block diagram and the combination of flows and/or blocks in the flow chart and/or block diagram can be realized by computer program instructions. These computer program instructions may be provided to a processor of a general-purpose computer, a special-purpose computer, an embedded processor, or other programmable data processing terminal device to generate a machine, so that instructions executed by the processor of the computer or other programmable data processing terminal devices generate a device for realizing the functions specified in one or more flows of the flowchart and/or one or more blocks of the block diagram.

These computer program instructions can also be stored in a computer-readable storage medium that can guide the computer or other programmable data processing terminal device to work in a specific way, so that the instructions stored in the computer-readable storage medium generate a manufactured product including an instruction device that implements the functions specified in one or more flows of the flowchart and/or one or more blocks of the block diagram.

These computer program instructions can also be loaded on the computer or other programmable data processing terminal devices, so that a series of operation steps are performed on the computer or other programmable terminal devices to produce computer implemented processing, Thus, instructions executed on the computer or other programmable terminal devices provide steps for realizing the functions specified in one or more flows of the flowchart and/or one or more blocks of the block diagram.

Although the preferred embodiments of the embodiments of the present disclosure have been described, those skilled in the art may make additional changes and modifications to these embodiments once they have learned the basic inventive concept. Therefore, the appended claims are intended to be interpreted as including preferred embodiments and all changes and modifications that fall within the scope of the embodiments of the present disclosure.

Finally, it should be noted that relationship terms such as first and second are only used herein to distinguish an entity or operation from another entity or operation, and it is not necessarily required or implied that there are any actual relationship or order of this kind between those entities and operations. Moreover, terms such as “comprise”, “comprising” and any other variants are intended to cover non-exclusive contains, so that the processes, methods, articles or devices including a series of elements not only include those elements but also include other elements that are not listed definitely, or also include the elements inherent in the processes, methods, articles or devices. In the case of no more restrictions, the elements defined by the statement ‘comprise one . . . ’ do not exclude that other same elements also exist in the processes, methods, articles or devices including the elements.

The above describes in detail a method for displaying groups, a device, a terminal, a server, a system and a storage medium provided by the present disclosure. In the disclosure, specific examples are applied to explain the principles and implementations of the present disclosure. The description of the above examples is only used to help understand the method and core idea of the present disclosure. At the same time, for those skilled in the art, according to the idea of the disclosure, there will be changes in the specific implementation mode and scope of application. To sum up, the content of the specification should not be understood as a limitation of the disclosure.

What is claimed is:

1. A method for displaying groups, comprising:
acquiring one or more target group types to be displayed in response to a group display operation of a user, wherein the target group types are determined based on behavior data of the user; and
acquiring groups corresponding to at least one of target group types, and displaying the groups on a group display page.

2. The method according to claim 1, further comprising:
acquiring the behavior data of the user, the behavior data of the user at least comprising source page information of the group display operation or historical association behavior information of the user implemented on multimedia resources; and
determining the one or more target group types according to the behavior data of the user.

3. The method according to claim 2, wherein the behavior data of the user comprises the historical association behavior information of the user implemented on the multimedia resources, and said determining the one or more target group types according to the behavior data of the user comprises:
determining works involved in the historical association behavior information of the user implemented on the multimedia resources within a preset historical period;
acquiring group tags carried by the works;
determining a confidence coefficient of the user for each type of group tag, wherein the confidence coefficient is configured to characterize a degree of interest of the user; and
determining the target group type according to the confidence coefficient for each type of group tag.

4. The method according to claim 3, wherein said determining the target group type according to the confidence coefficient for each type of group tag comprises:
determining the target group type based on a group type corresponding to a group tag with the confidence coefficient greater than a preset threshold;
wherein said acquiring the groups corresponding to at least one of the target group types, and displaying the groups on the group display page comprises:
selecting the groups based on each target group type, and displaying the groups on the group display page in an order of confidence coefficients corresponding to respective target group types from high to low.

5. The method according to claim 3, wherein said acquiring the groups corresponding to at least one of the target group types, and displaying the groups on the group display page comprises:
displaying group types corresponding to respective group tags on the group display page in an order of the confidence coefficients corresponding to respective group tags from high to low; and
acquiring the groups based on a group type with the confidence coefficient greater than a preset threshold, and displaying the groups in a designated region of the group display page.

6. The method according to claim 3, wherein said determining the confidence coefficient of the user for each type of group tag comprises:
counting a number of group tags for each type and a total number of all group tags; and
acquiring the confidence coefficient for each type of group tag based on a quotient value of the number of group tags for each type and the total number of all group tags.

7. The method according to claim 3, wherein the historical association behavior information comprises information of published works and information of browsed works; and
said determining the confidence coefficient of the user for each type of group tag comprises:
determining published works of the user within the preset historical period according to information of the published works of the user within the preset historical period;
acquiring group tags carried by the published works;
determining a first confidence coefficient of the user for each type of group tag based on the group tags carried by the published works;
determining browsed works of the user within the preset historical period according to information of the browsed works of the user within the preset historical period; and
acquiring group tags carried by the browsed works;
determining a second confidence coefficient of the user for each type of group tag based on the group tags carried by the browsed works; and
acquiring the confidence coefficient of the user for each type of group tag by weighting the first confidence coefficient and the second confidence coefficient.

8. The method according to claim 3, wherein said acquiring the group tags carried by the works comprises:
acquiring a set of feature words of the works, wherein the set of feature words at least comprises content feature words, title segmentation and description information segmentation; and
acquiring the group tags carried by the works by inputting the set of feature words into a pre-trained group tag classification model, wherein the group tag classification model is acquired by training a preset model using a set of feature words of published works as training samples.

9. The method according to claim 1, wherein the behavior data of the user is the source page information of the group display operation, and said determining the one or more target group types according to the behavior data of the user comprises:
acquiring a group tag carried by a source page of the group display operation according to the source page information of the group display operation; and
determining the target group type based on the group type corresponding to the group tag.

10. The method according to claim 9, wherein said acquiring the groups corresponding to at least one of the target group types, and displaying the groups on the group display page comprises:
displaying the target group type on top of the group display page, wherein the group type corresponding to each type of group tag is displayed on the group display page; and
acquiring the groups corresponding to the target group type, and displaying the groups in a designated region of the group display page.

11. The method according to claim 9, wherein said acquiring the group tag carried by the source page of the group display operation according to the source page information of the group display operation comprises:
acquiring, according to a browsing history of the user on the source page, the group tag and a plurality of types of sub-tags corresponding to the group tag;
the method further comprises:
determining a confidence coefficient of the user for each type of sub-tag;
wherein said acquiring the groups corresponding to at least one of the target group types, and displaying the groups on the group display page comprises:
acquiring groups corresponding to at least one of the target group types and in accord with respective types of sub-tags; and
displaying the groups in a designated region of the group display page in an order of confidence coefficients for respective types of the sub-tags from high to low.

12. The method according to claim 1, further comprising:
acquiring the behavior data of the user, the behavior data of the user at least comprising source page information of the group display operation or historical association behavior information of the user implemented on multimedia resources;
sending the behavior data of the user to a server, wherein the server is configured to determine the one or more target group types according to the behavior data of the user; and
receiving the one or more target group types returned by the server.

13. A method for displaying groups, comprising:
receiving behavior data of a user sent by a terminal, wherein the behavior data of the user at least comprises source page information of a group display operation or historical association behavior information of the user implemented on multimedia resources;
determining one or more target group types according to the behavior data of the user; and
sending the one or more target group types to the terminal to enable the terminal to acquire groups corresponding to at least one of the target group types and display the groups on a group display page in response to detecting the group display operation of the user.

14. The method according to claim 13, wherein the behavior data of the user comprises the historical association behavior information of the user implemented on the multimedia resources, and said determining the one or more target group types according to the behavior data of the user comprises:
determining works involved in the historical association behavior information of the user within a preset historical period;
acquiring group tags carried by the works;
determining a confidence coefficient of the user for each type of group tag, wherein the confidence coefficient is configured to characterize a degree of interest of the user; and
determining the target group type according to the confidence coefficient for each type of group tag.

15. The method according to claim 13, wherein said determining the confidence coefficient of the user for each type of group tag comprises:
counting a number of group tags for each type and a total number of all group tags; and
acquiring the confidence coefficient for each type of group tag based on a quotient value of the number of group tags for each type and the total number of all group tags.

16. The method according to claim 14, wherein the historical association behavior information comprises information of published works and information of browsed works; and
said determining the confidence coefficient of the user for each type of group tag comprises:
determining published works of the user within the preset historical period according to information of the published works of the user within the preset historical period;
acquiring group tags carried by the published works;
determining a first confidence coefficient of the user for each type of group tag based on the group tags carried by the published works;
determining browsed works of the user within the preset historical period according to information of the browsed works of the user within the preset historical period;
acquiring group tags carried by the browsed works;
determining a second confidence coefficient of the user for each type of group tag based on the group tags carried by the browsed works; and
acquiring the confidence coefficient of the user for each type of group tag by weighting the first confidence coefficient and the second confidence coefficient.

17. The method according to claim 14, wherein said acquiring the group tags carried by the works comprises:
acquiring a set of feature words of the works, wherein the set of feature words at least comprises content feature words, title segmentation and description information segmentation; and
acquiring the group tags carried by the works by inputting the set of feature words into a pre-trained group tag classification model, wherein the group tag classification model is acquired by training a preset model using a set of feature words of published works as training samples.

18. The method according to claim 13, wherein the behavior data of the user is the source page information of the group display operation, determining the one or more target group types according to the behavior data of the user comprises:
acquiring a group tag carried by a source page of the group display operation according to the source page information of the group display operation; and
determining the target group type based on the group type corresponding to the group tag.

19. The method according to claim 18, wherein said acquiring the group tag carried by the source page of the group display operation according to the source page information of the group display operation comprises:
acquiring, according to a browsing history of the user on the source page, the group tag and a plurality of types of sub-tags corresponding to the group tag;
the method further comprises:
determining a confidence coefficient of the user for each type of the sub-tag;
wherein said sending the one or more target group types to the terminal comprises:
sending the one or more target group types and the confidence coefficient of each type of sub-tag to the terminal, to enable the terminal to acquire groups corresponding to at least one of the target group types and in accord with respective types of sub-tags and display the groups in a designated region of the group display page in an order of confidence coefficients for the respective types of the sub-tags from high to low in response to detecting the group display operation of the user.

20. An apparatus for displaying groups, comprising:
a processor; and
a memory for storing executable instructions of the processor;
wherein, the processor is configured to perform acts for implementing:
acquiring one or more target group types to be displayed in response to a group display operation of a user, wherein the target group types are determined based on behavior data of the user; and
acquiring groups corresponding to at least one of the target group types, and display the groups on a group display page.
